(19) United States
(12) Patent Application Publication
(10) Pub. No.: US 2019/0095831 A1
(43) Pub. Date: Mar. 28, 2019

(54) SYSTEM AND METHOD FOR PRESERVING FORESTS AND CERTIFYING THE SUPPLY CHAIN OF LUMBER

(71) Applicant: Earth Observation Inc., San Francisco, CA (US)

(72) Inventors: Andrew Dudley, Corte Madera, CA (US); Jesse House, June Lake, CA (US); Elliot Dudley, Corte Madera, CA (US)

(21) Appl. No.: 15/717,523

(22) Filed: Sep. 27, 2017

(51) Int. Cl. G06Q 10/06; H04W 4/021

(52) U.S. Cl. CPC G06Q 10/0637; G06Q 50/02; H04W 4/021

(57) ABSTRACT

A method and apparatus for registering an individual, registering an area of land, establishing a geofence and satellite tracking for the area of land, identifying trees within the area of land, providing certification for the preservation or logging of trees, and for the latter, tracking the transfer of wood from the forest to the mill and beyond is disclosed. Certification of the tree or volume of wood and the persons involved can be verified when the tree or its wood is transferred from one person to the next, using an analysis of that person's role and function relative to their time, date and physical location.

### TECHNICAL FIELD

A method and apparatus for registering an area of land, establishing a geofence and satellite tracking for the area of land, identifying and performing registration of trees within the area of land, providing verification of the preservation of those trees or the certification for the production of those trees, and tracking the transfer of the tree or its wood from the forest to the mill and beyond is disclosed. Certification can be verified when the tree or its wood is transferred from one person to the next person in the supply chain, thereby creating a secure digital ledger, whereby historic ownership and transfer records are preserved, optionally using blockchain technology.

### BACKGROUND OF THE INVENTION

Illegal deforestation is a rampant, worldwide problem with deleterious environmental consequences. Governments throughout the equatorial tropics have attempted to regulate deforestation but have had poor results in enforcement, especially due to the remoteness of the rainforests and the fact that there is little oversight in the ‘first mile of supply’ or prior to the first point of processing and from where the trees our coming from. This situation is further exacerbated by the reliance on paper based systems that are vulnerable to fraudulent acts, which adds to the widespread corruption of the illegal logging industry. For example, governments will often issue licenses for legal deforestation and will attempt to punish anyone who cuts down a tree without a license. However, it has become common for loggers to use fake licenses or to use a valid license for activities outside the scope of the license. For example, if a license permits a company to log 100 trees, the company may log 200 trees and use the license to export all 200 trees in two different batches. Fraud and corruption are endemic throughout the supply chain. The physical remoteness of these areas mean that conducting in-person audits can be very costly and unreliable, as those responsible for conducting such audits in some instances will themselves be corrupt and willing to approve a physical inspection without ever visiting the forest or seeing the actual wood that allegedly was lawfully logged from that forest.

What is needed is a secure digital system to replace the prior art paper-based systems to counteract the influence and control of corrupt officials and criminal elements. Ideally, the system would be for the exclusive use of pre-approved logging concessions, their employees, authorized inspectors or auditors approved by a government entity or independently registered and tracked auditors. Such a system can include components for registering individuals, establishing a data trail of human activity, issuing a license, tagging and identifying the location and species of individual or groups of trees, and verifying that these trees are being and/or have been preserved or cut down by way of a physical audit or drone, aircraft or satellite imagery which will show that trees have been preserved or a structural change in the rainforests canopy confirms that a tree or group of trees have been removed. By confirming such structural changes in the rainforest canopy and then certifying that the tree in question was lawfully cut down pursuant to a license by a known or trusted individual. What is further needed is a mechanism for tracking the transfer and movement of the tree or its wood from the forest to the mill and beyond. What is further needed is a mechanism that will identify spikes or abnormalities in the supply chain where the volume of wood being handled by one person is greater than the volume being handled by the next person.

### SUMMARY OF THE INVENTION

A method and apparatus for registering an area of land, establishing a geofenced area, initiating satellite, aircraft or drone monitoring for the area of land, identifying trees and tree species within the area of land, providing certification for the preservation or logging of trees, and tracking the transfer of wood from the tree stump to the mill and beyond is disclosed.

The embodiments disclosed herein allow for the registration of persons involved in the entire supply chain of the wood that is milled from a particular tree removed from the forest, as well as persons involved in inspections and audits. By tracking the relationships through which the commodities flow, the system enhances trust and accountability around each individual in the supply chain. The embodiments further establish a maximum volume or estimated yield for each person or node in the supply chain based on their time, date and physical location or recognized geo-fenced zone. By tracking the flow of wood as it moves from one person to the next, we can verify the volume as it moves along the supply chain and identify abnormalities that may indicate that illegal deforestation or the introduction of illegally sourced wood being introduced into the digital supply chain.

### BRIEF DESCRIPTION OF THE DRAWINGS

FIG. 1 depicts hardware components of prior art mobile device

FIG. 2 depicts software components of a mobile device.

FIG. 3 depicts the mobile device in communication with a server.

FIG. 4 depicts a system and method for certifying the supply chain of lumber.

FIG. 5 depicts registration of a polygon of land.

FIG. 6 depicts actions taken by a surveyor using a mobile device.

FIG. 7 depicts actions taken by a logger using a mobile device.

FIG. 8 depicts actions taken by a log yard manager using a mobile device.

FIG. 9 depicts actions taken by a log yard manager using a mobile device.

FIG. 10 depicts actions taken by a driver using a mobile device.

FIG. 11 depicts actions taken by a driver using a mobile device.

FIG. 12 depicts actions taken by a miller using a mobile device.

FIG. 13 depicts actions taken by a miller using a mobile device.

FIG. 14 depicts actions taken by a concession administrator using a mobile device.

FIG. 15 depicts actions taken by a government official using a mobile device.

FIG. 16 depicts information captured by mobile devices operated by various individuals in the supply chain of lumber.

FIG. 17 depicts a handshaking process between two mobile devices during a transaction.

FIG. 18 depicts a method for issuing a license for the logging of trees.

FIG. 19 depicts an exemplary forest.

FIG. 20 depicts an embodiment of a tree tagging system.

FIG. 21 depicts the exemplary forest after a tree has been cut down.

FIG. 22 depicts images of the forest before and after the tree has been cut down.

FIG. 23 depicts a cross-section of the tree.

FIG. 24 depicts an image of the cross-section of the top of the residual tree stump or tree trunk.

FIG. 25 depicts a geofencing aspect of the tree tagging system.

FIG. 26 depicts a computing device in communication with the server.

FIG. 27 depicts photographs of the cross-sections of trees.

FIG. 28 depicts a method of tagging and certifying a tree.

FIG. 29 depicts a method of certifying the exportation of a particular tree.

FIG. 30 depicts an embodiment of tracking a tree and lumber and furniture made from that tree.

FIG. 31 depicts an embodiment of a mobile device used by a miller.

FIG. 32 depicts an embodiment of a mobile device used by a furniture maker.

FIG. 33 depicts an embodiment for tracking the movement and transfer of wood from the logger to the miller to the furniture maker.

### DETAILED DESCRIPTION OF THE PREFERRED EMBODIMENTS

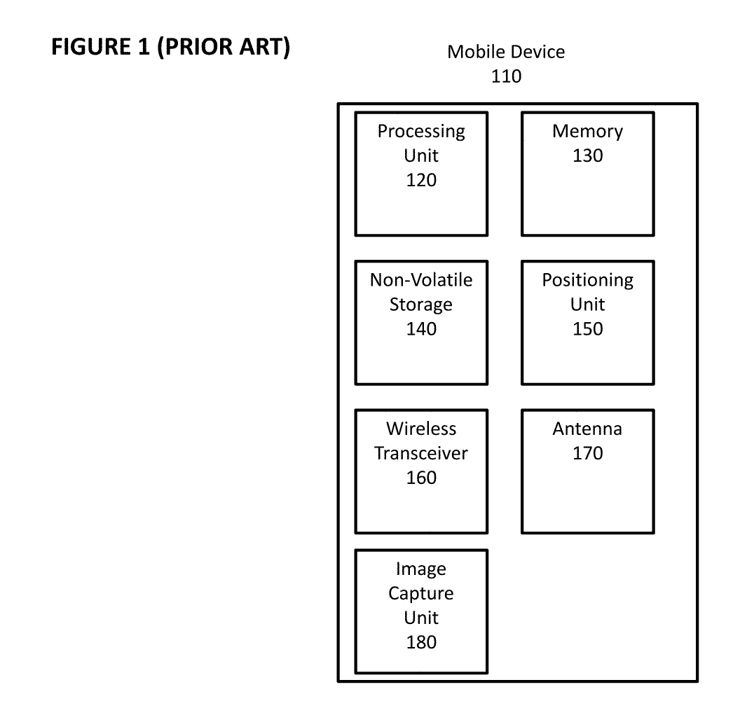

With reference to FIG. 1, hardware components of mobile device 110 are depicted. These hardware components are known in the prior art, and as to hardware, mobile device 110 is a prior art device. Mobile device 110 comprises processing unit 120, memory 130, non-volatile storage 140, positioning unit 150, wireless transceiver 160, antenna 170, and image capture unit 180. Positioning unit 150 can comprise, for example, a GPS unit or GNSS unit that communicates with GPS or GNSS satellites to determine latitude and longitude coordinates for mobile device 110, usually output as latitude data 620 and longitude data 630 (not shown). Non-volatile storage 140 optionally is a hard disk drive or flash memory array. Wireless transceiver 160 can engage in wireless communication over a cellular network (e.g., 3G, 4G, GSM, etc.), WiFi network (e.g., 802.11), or other radio frequency communication network. Wireless transceiver 160 also can engage in wireless communication known by the trademark “Bluetooth.” Image capture unit 180 can comprise one or more standard cameras (as is currently found on most mobile phones), or it can comprise one or more infrared image capture devices for capturing data using infrared light sensors. This can be useful, for example, in extremely low-light environments, such as in a deep forest. Mobile device 110 can be a smartphone, notebook computer, tablet, wearable computing device such as a watch or glasses, or any other computing device that can be easily transported by a user.

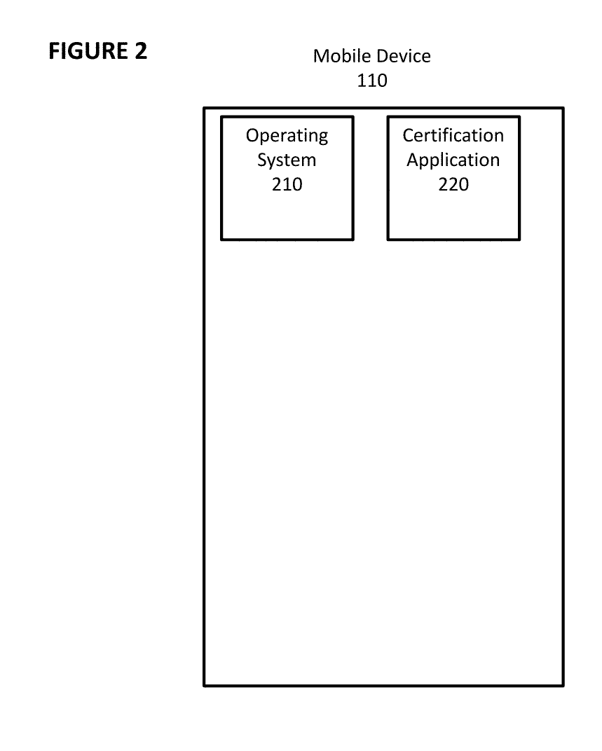

With reference to FIG. 2, software components of mobile device 110 are depicted. Mobile device 110 is used in the embodiments described herein. Mobile device 110 comprises operating system 210 (such as the operating system known by the trademarks “Android” or “iOS”) and certification application 220. Certification application 220 comprises lines of software code executed by processing unit 120 to perform the functions described below. For example, mobile device 110 can be a phone sold with the trademark “Galaxy” by Samsung or “iPhone” by Apple, and certification application 220 can be a downloadable app installed on the phone. Certification application 220 forms an important component of the inventive aspect of the embodiments described herein, and certification application 220 is not known in the prior art.

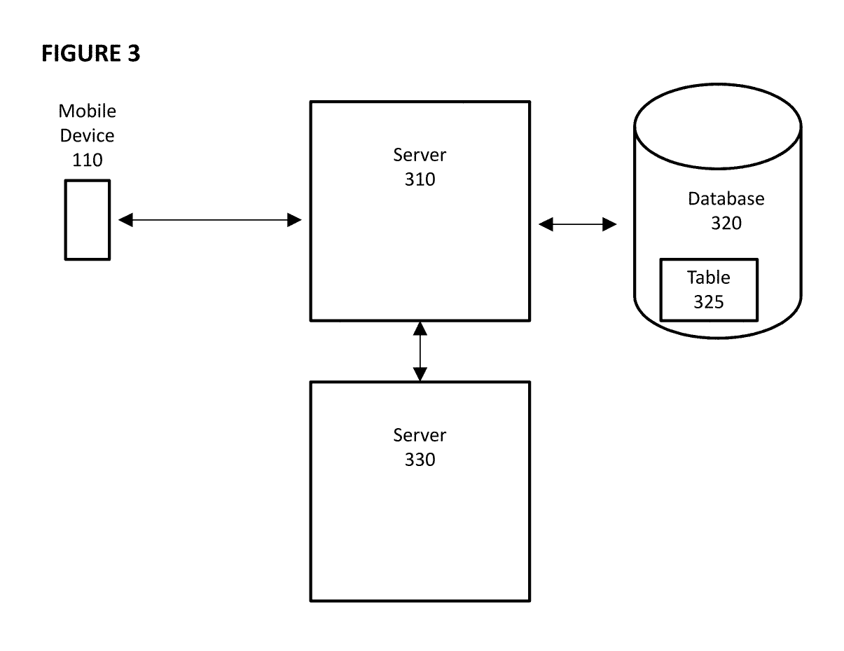

With reference to FIG. 3, mobile device 110 communicates with server 310 over a wireless network using wireless transceiver 160. Server 310 accesses database 320. Server 310 also communicates with server 330 over the Internet or other network.

The hardware and software components shown in FIGS. 1-3 are utilized in the embodiments described below.

### First Embodiment: Certification of Supply Chain

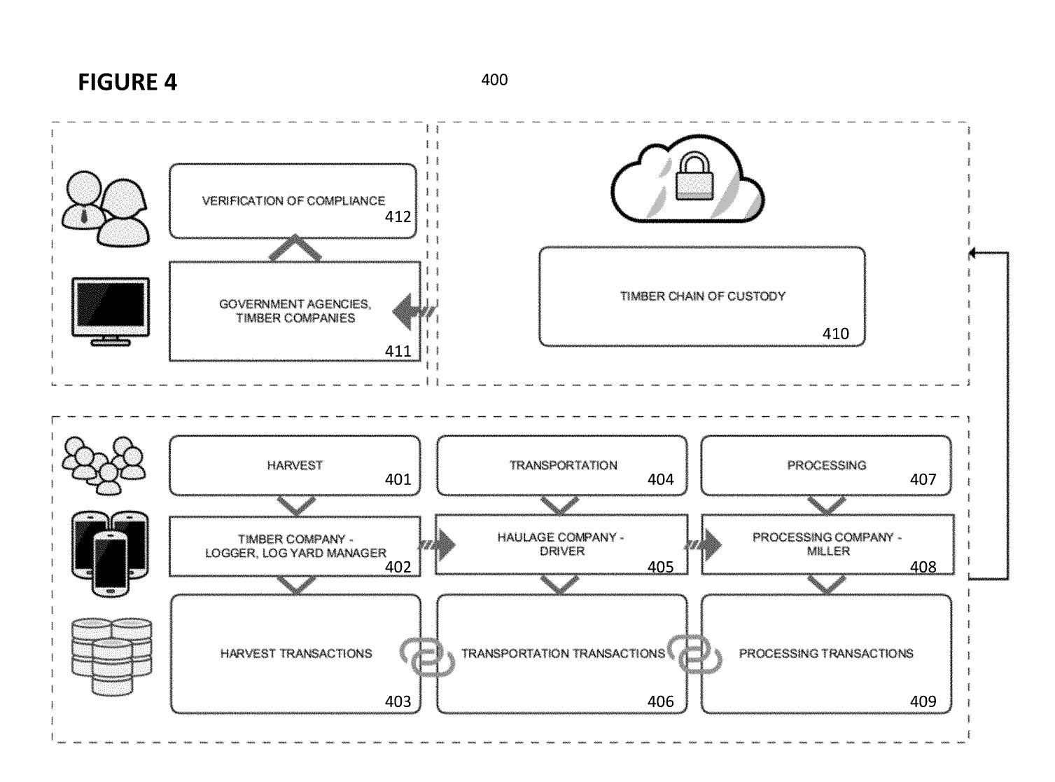

A first embodiment will now be described. With reference to FIG. 4, certification system and method 400 is depicted. Certification system and method 400 provides a certification mechanism for the entire supply chain for a commodity. In this example, the commodity is trees/lumber. The supply chain comprises entities and persons involved in harvest sector 401, transportation sector 404, and processing sector 407.

Harvest sector 401 typically involves a timber company 402, which might include loggers and log yard managers that engage in harvest transactions 403. Transportation sector 404 typically involves a haulage company 405, which might include drivers that engage in transportation transactions 406. Processing sector 407 typically involves a processing company 408, which might include millers that engage in processing transactions. Individuals from these various sectors interact with one another, as will be discussed in detail below.

Certification system and method 400 provides chain of custody certification 410 for the entire supply chain and all sectors. This allows government officials 411 and others to analyze each player and each transaction and to generate verification of compliance 412.

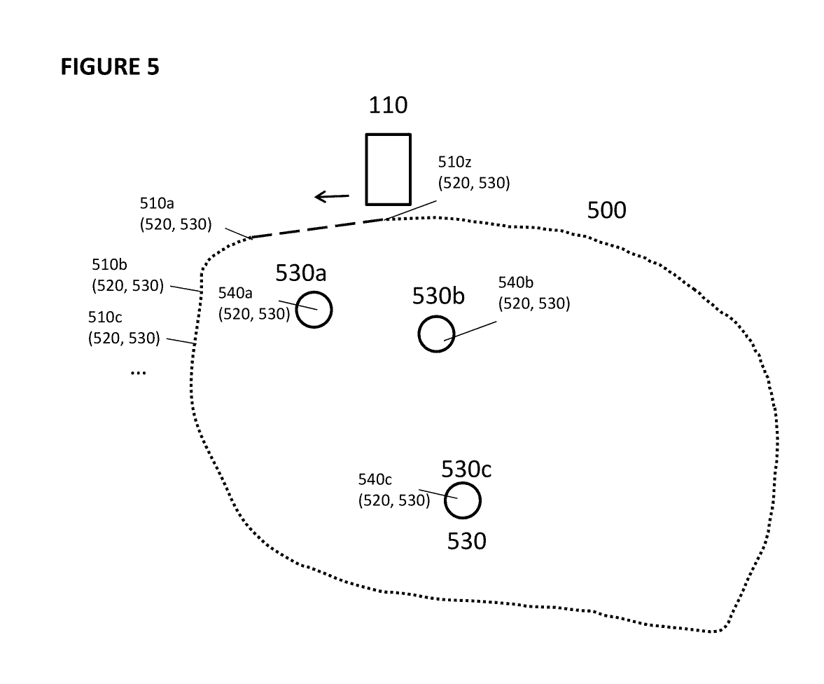

The supply chain will now be described, beginning with harvest sector 401. With reference to FIG. 5, a bird's eye view of a forest is shown. In this embodiment, a surveyor carries mobile device 110 and walks or drives around a polygon of land, here shown as land area 500. Certification application 220 continually captures GPS/GNSS data comprising latitude data 520 and longitude data 530 and stores such data as datasets 510a, 510b, 510c, . . . 510z, which are stored in non-volatile storage 150. Mobile device 110 also captures GPS/GNSS data for trees 530a, 530b, and 530c as datasets 540a, 540b, and 540c, respectively. These trees are exemplary, and land area 500 can comprise many more trees than the ones shown.

Mobile device 110 optionally receives data from the surveyor about each particular tree, such as height and circumference data and type of tree. Thus, mobile device 110 is used to survey land area 500 and trees contained therein. Land area 500 might constitute a parcel of land owned by an individual, a company, or the government, or it might be a parcel of land designated by the government for logging or preservation. Optionally, the surveyor can take a physical sample from each tree and generate records specific to that tree, such as DNA data or isotope data. That data can be stored in non-volatile storage 150 and associated with the particular tree from which the physical sample was taken.

The data captured by mobile device 110 can be uploaded to server 310 at the time of capture using wireless transceiver 160 or at a later time if mobile device 110 has no wireless connectivity at the time of capture. Server 310 then will create a data record for land area 500 and store the record in database 320, for example, as table 325. The data record, such as table 325, can also store the data, such as DNA data or isotope data, collected from physical samples of trees.

Server 310 can determine or estimate the maximum possible volume or weight of wood existing within land area 500, using estimates based on collected tree data or based on statistics gathered from other land in that area. For example, a forest in Guatemala might support, at most, four mahogany trees of 80 tons each within an acre of land.

Optionally, a community auditor can at any time can visit land area 500 and confirm that the trees recorded for land area 500 are correct and that the only trees that are missing are those that were reported to server 310 as being harvested from land area 500.

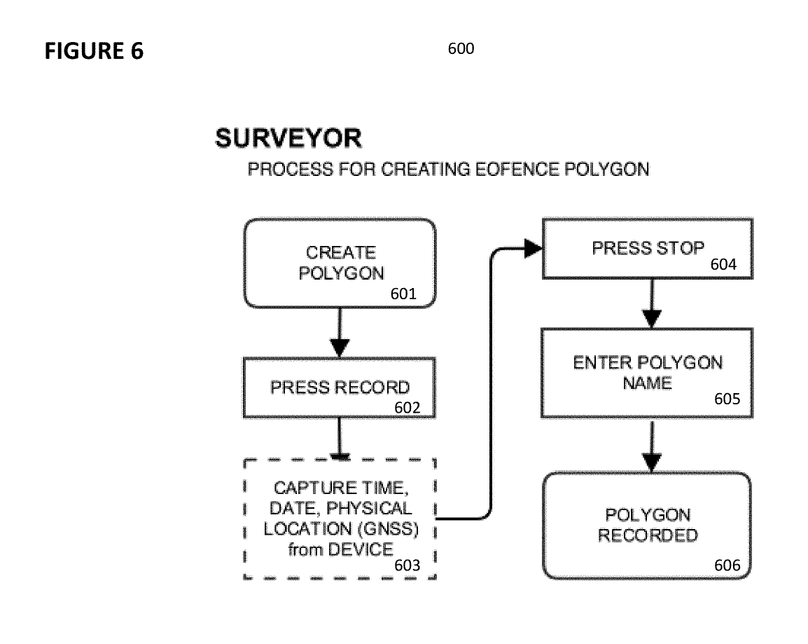

With reference to FIG. 6, additional detail is depicted regarding the actions of the surveyor. In survey method 600, surveyor uses mobile device 110 to create polygon 500 (step 601), in the manner described previously with reference to FIG. 5. The surveyor initiates the record process within certification application 220 as to polygon 500 (step 602), which causes mobile device 110 to capture the date and time and the physical location (GPS/GNSS) from mobile device 110 (step 603). The surveyor ends the record process within certification application 220 as to polygon 500 (step 604). The surveyor enters a name for polygon 500, such as “John's Land.” Polygon 500 is then recorded in non-volatile storage 140 and loaded to server 310 at that time or a later time when wireless connectivity is available.

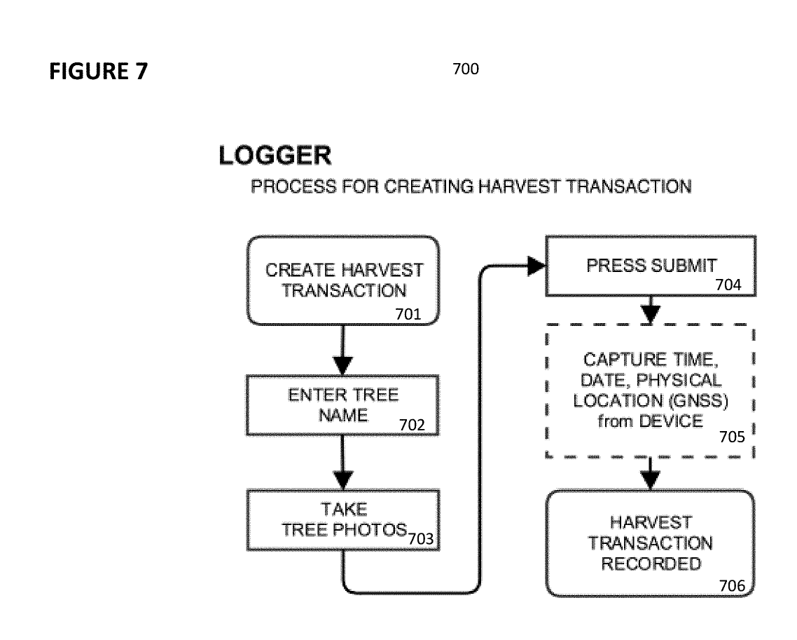

The next step is for trees to be harvested. FIG. 7 depicts actions taken by a logger. In logging method 700, the logger creates a harvest transaction using mobile device 110 (step 701). The logger enters a name or description for a tree, such as “Mahogany No. 1” (step 702). The logger optional takes photos of the tree to be cut down using mobile device 110 (step 703). The logger then presses “submit” in certification application 220 (step 704), which causes mobile device 110 to capture the date and time and physical location (GPS/GNSS data) of mobile device 110 (step 705). The harvest transaction is then stored in non-volatile storage 140 and loaded to server 310 at that time or a later time when wireless connectivity is available. The logger cuts down a certain number of trees and performs logging method 700 for each tree.

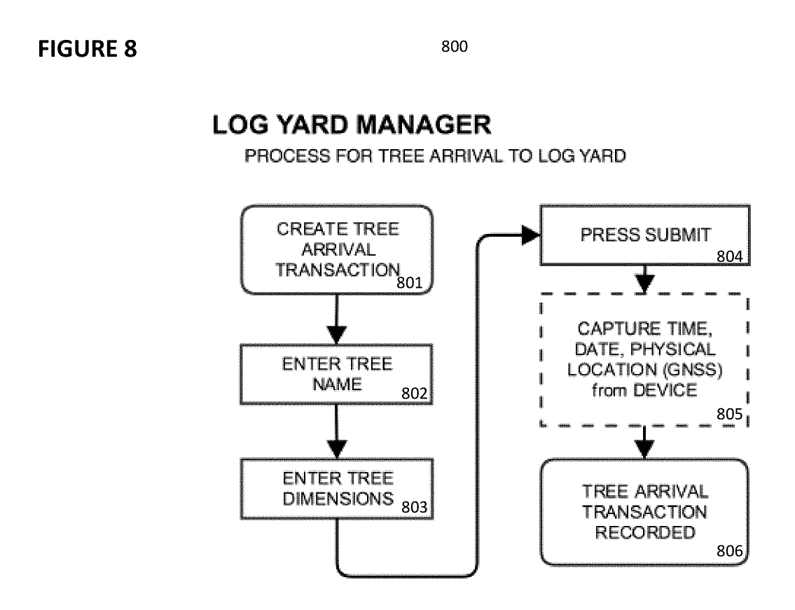

The logger then takes the trees to the log yard. FIG. 8 depicts the transfer of the trees to the log yard. In log yard method 800, the log yard manager uses mobile device 110 to create a tree arrival transaction (step 801). The log yard manager enters the name of the tree, such as “Mahogany No. 1” (step 802). The log yard manager enters the tree dimensions (step 803). The log yard manager presses “submit” within certification application 220 (step 804), which causes mobile device 110 to capture the date and time and physical location (GPS/GNSS) of the mobile device 110. The tree arrival transaction is then recorded in non-volatile storage 140 (step 806) and loaded to server 310 at that time or a later time when wireless connectivity is available. The log yard manager performs the log yard method 800 for each log received.

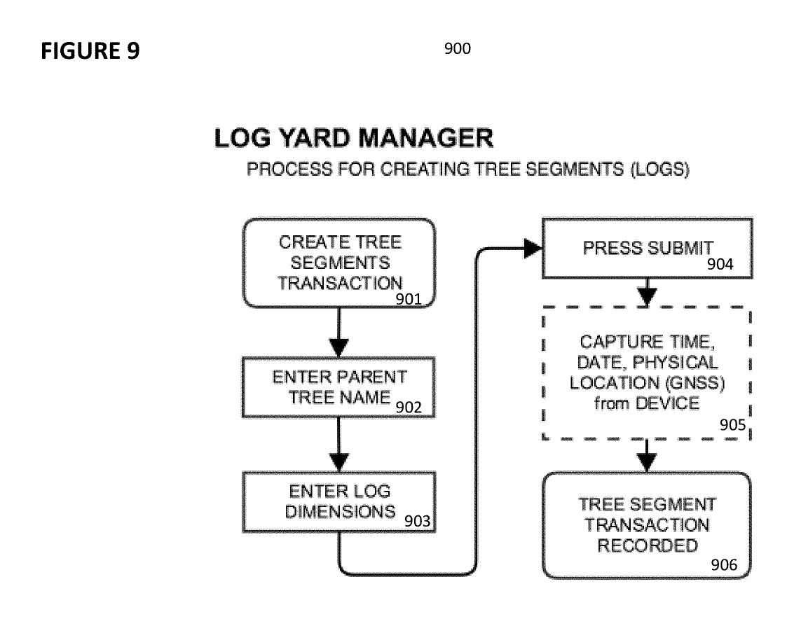

The log yard manager then creates tree segments or logs from each tree. FIG. 9 depicts the creation of tree segments. In tree segment method 900, the log yard manager uses mobile device 110 to create a tree segment transaction (step 901). The log yard manager enters the name of the parent tree, such as “Mahogany No. 1” (step 902). The log yard manager enters the log dimensions (step 903). The log yard manager presses “submit” within certification application 220 (step 904), which cases mobile device 110 to capture the time, data, and physical location (GPS/GNSS) of mobile device 110 (step 905). The tree segment transaction is then recorded in non-volatile storage 140 and loaded to server 310 at that time or a later time when wireless connectivity is available. The log yard manager performs the tree segment transaction for each tree segment.

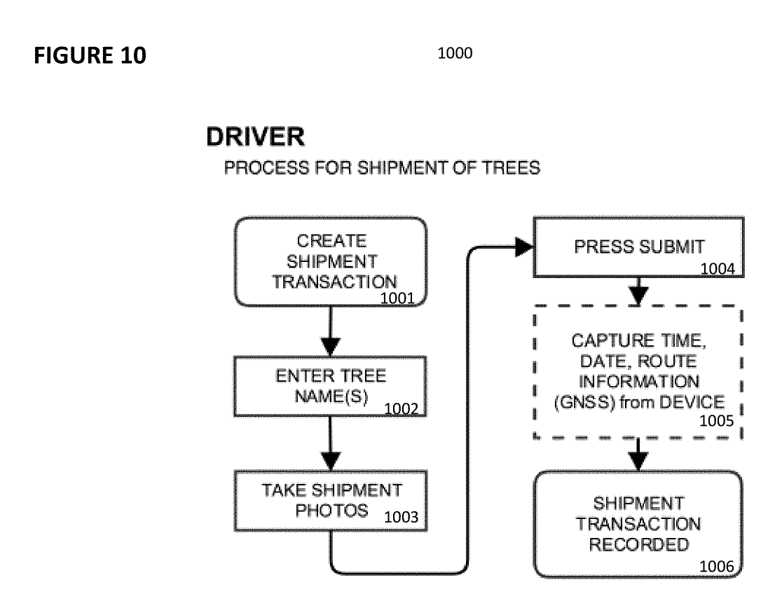

A driver then picks up the trees from the log yard. FIG. 10 depicts steps taken by the driver. In driver method 1000, the driver uses mobile device 110 to create a shipment transaction (step 1001). The driver enters the name of the parent tree, such as “Mahogany No. 1” (step 1002). The driver takes shipment photos (step 1003). The driver presses “submit” within certification application 220 (step 904), which causes mobile device 110 to capture the time, data, and physical location (GPS/GNSS) of mobile device 110 (step 1005). The shipment transaction is then recorded in non-volatile storage 140 and loaded to server 310 at that time or a later time when wireless connectivity is available.

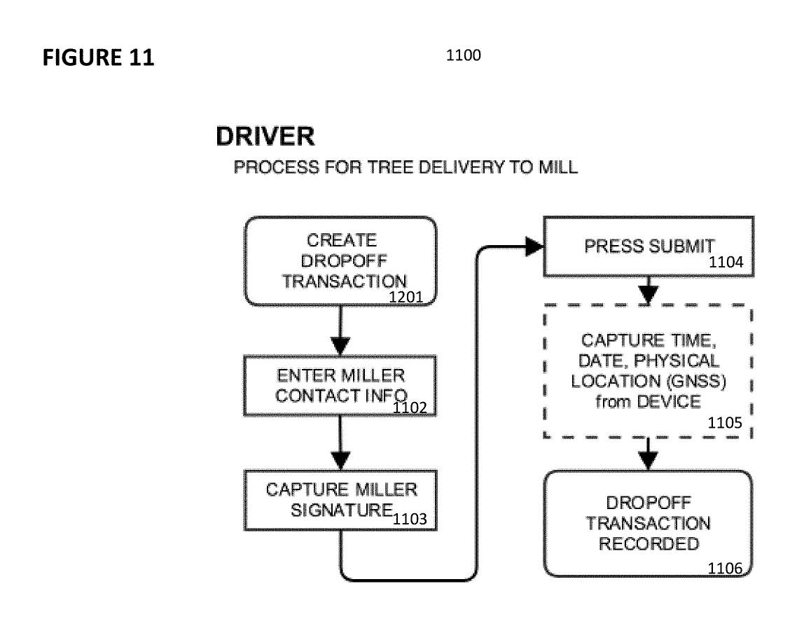

The driver then takes the logs to the mill. FIG. 11 depicts steps taken by the driver. In drop off method 1100, the driver uses mobile device 110 to create a drop off transaction (step 1101). The driver enters the miller's contact information (step 1102). The driver captures the miller's signature (step 1103). The driver presses “submit” within certification application 220 (step 1104), which causes mobile device 110 to capture the time, data, and physical location (GPS/GNSS) of mobile device 110 (step 1005). The dropoff transaction is then recorded in non-volatile storage 140 (step 1106) and loaded to server 310 at that time or a later time when wireless or cellular connectivity is available. The truck's route is also recorded so we know when and where the truck has been.

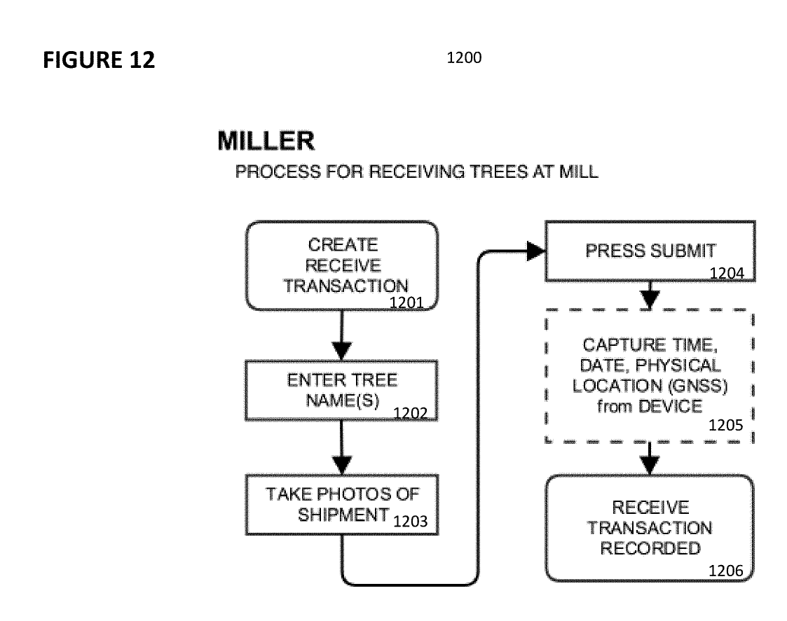

The miller then receives the logs at the mill. FIG. 12 depicts steps taken by the miller. In miller method 1200, the miller uses mobile device 110 to create a receive transaction (step 1201). The miller enters the tree name, such as “Mahogany No 1” (step 1202). The miller takes photos of the shipment (step 1203). The miller presses “submit” within certification application 220 (step 1204), which causes mobile device 110 to capture the time, data, and physical location (GPS/GNSS) of mobile device 110 (step 1205). The receive transaction is then recorded in non-volatile storage 140 (step 1206) and loaded to server 310 at that time or a later time when wireless connectivity is available.

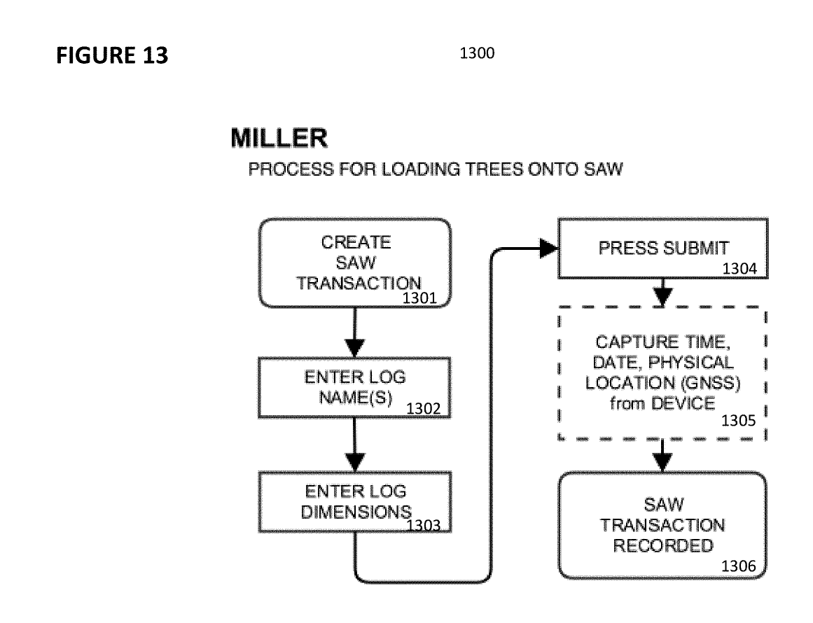

The miller then cuts the logs into timber. FIG. 13 depicts steps taken by the miller. In miller method 1300, the miller uses mobile device 110 to create a receive transaction (step 1301). The miller enters the log name (step 1302). The miller enters the log dimensions (step 1303). The miller presses “submit” within certification application 220 (step 1304), which causes mobile device 110 to capture the time, data, and physical location (GPS/GNSS) of mobile device 110 (step 1305). The receive transaction is then recorded in non-volatile storage 140 (step 1306) and loaded to server 310 at that time or a later time when wireless connectivity is available. The miller performs miller method 1300 for each log.

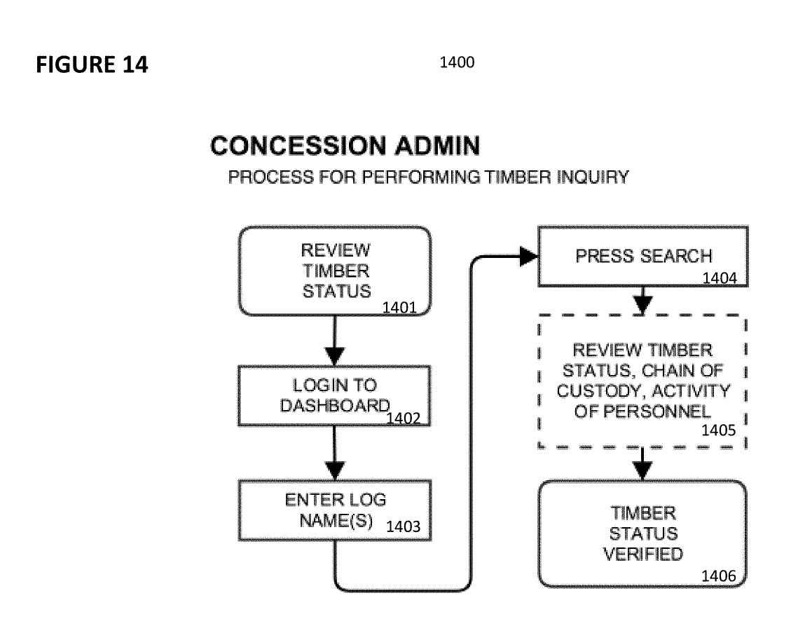

FIG. 14 depicts steps taken by a concession administrator. The administrator begins the “Review Timber Status” mode within certification application 220 (step 1401). The administrator logs in (step 1402). The administrator provides the name of a log (step 1403). The administrator presses “search” (step 1404). Certification application 220 then displays timber status, chain of custody information, and the activity of personnel in the chain of custody (step 1405). This allows administrator to verify the status of the timber (step 1406).

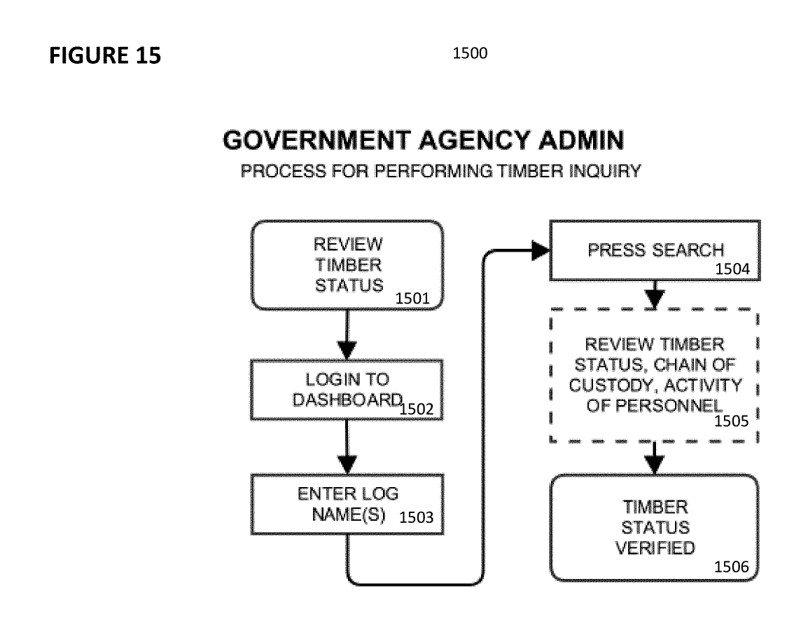

FIG. 15 depicts steps taken by a government official. The official begins the “Review Timber Status” mode within certification application 220 (step 1501). The official logs in (step 1502). The official provides the name of a log (step 1503). The official presses “search” (step 1504). Certification application 220 then displays timber status, chain of custody information, and the activity of personnel in the chain of custody (step 1505). This allows administrator to verify the status of the timber (step 1506).

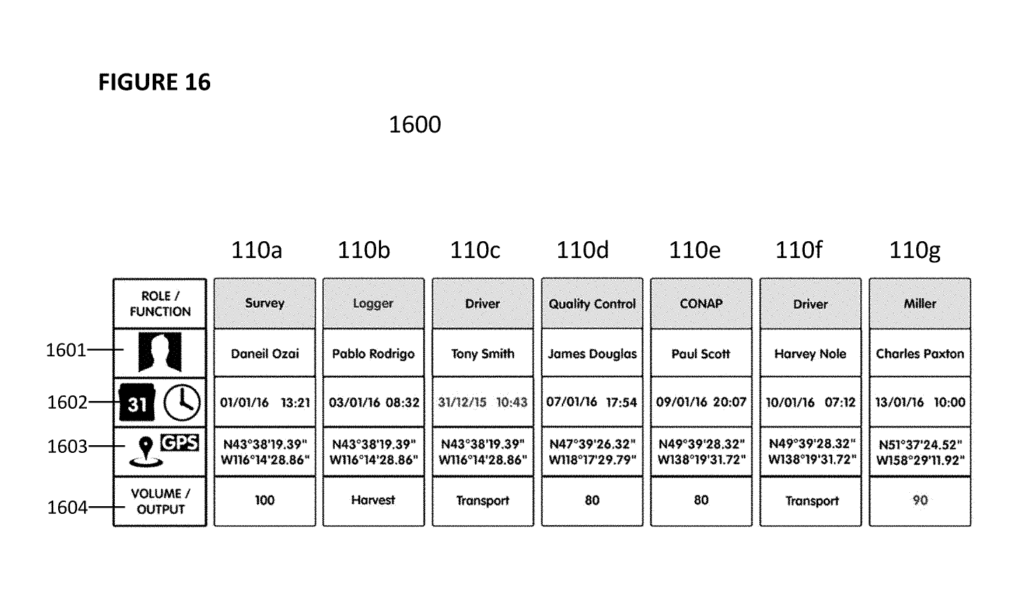

The various instantiations of mobile device 110 used by the players in the supply chain are depicted in FIG. 16. Mobile device 110a is operated by a surveyor, mobile device 110b by a logger, mobile device 110c by a driver, mobile device 110d by a quality control administrator, mobile device 110e by a government official, mobile device 110f by another driver, and mobile device 110g by a miller. Ideally, each person involved in the supply chain of wood from the time a tree is logged to the time it is milled into lumber (including all drivers of trucks that carry the tree or its wood and all ship captains who transport the tree or its wood by ship) will use an instantiation of mobile device 110, such that the item will only be handled by those who are registered with server 310.

Each of these mobile devices 110 capture the following information using certification application 220: ID 1701 for the operator, date and time 1702, GPS/GNSS information 1703, and volume or output 1704. Volume or output 1704 is a measurement or estimate provided by the operator of the mobile device for a transaction, such as 100 trees or 80 pieces of 2″×4″ timber of 20 feet each.

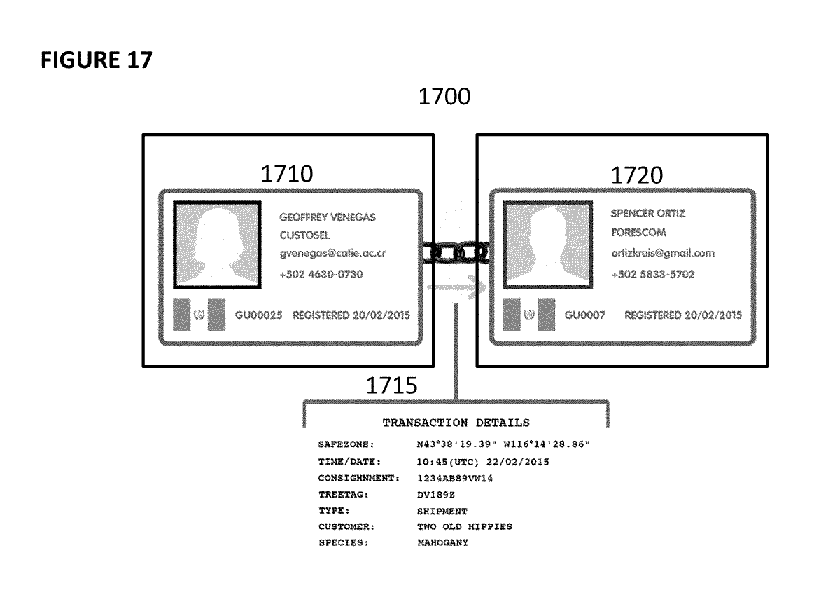

In the steps described above, a handshaking protocol can be used when the commodity changes hands between people (e.g., when a driver picks up the trees from a logger, or the miller receives the trees from a driver). Handshaking protocol 1700 is depicted in FIG. 17. With each transfer, two mobile devices engage in a handshake protocol using certification application 220 or another software application. The communication optionally is performed using wireless communication protocols known by the trademarks “Bluetooth,” “802.11,” and “WiFi.” Optionally, one or both devices also can communicate with server 310. During the handshake protocol, the authenticity of the operators of the mobile devices will be verified optionally using authentication credentials stored within certification application 220, such as authentication credentials 1710 and 1720, and both mobile devices will indicate the transfer of the item from the owner of one mobile device to the owner of the other mobile device. Transaction details 1715 will be captured, such as GPS/GNSS information, time, date, consignment number, tree identification, the type of transaction, the name of the customer/receiver, and the species of the tree or log. Optionally, transaction details 1715 can be recorded in a blockchain, which is a digital ledger that cannot be edited or manipulated by fraudulent activity.

Optionally, the handshaking can be initiated by one mobile device sending an invitation to another mobile device (e.g., from a logger to a driver), which can create a “network of trust” that will provide a further layer of security. Optionally, the handshaking can involve verification of the volume or weight of the item being transferred, and this information can be logged in server 310. If a discrepancy arises (for example, if the number of trees provided by a logger to a miller exceeds the number of trees contained in polygon 500 by a predetermined threshold percentage or amount, or if the volume of lumber transported by a truck exceeds the volume threshold of the maximum volume that a truck could transport given the capacity of the truck, and the average possible speed of the truck), then server 310 or the receiving mobile device can deny the transfer, flag the occurrence of a potentially illegal event, or generate another type of alert or notification. Here, an alert or notification at any stage within the supply chain may indicate potential fraudulent activity, as the volume of wood that leaves a certain person's possession should never exceed the volume originally received by that person. The alert or notification can be generated any of the mobile devices 110 operated by the individuals in the supply chain. If an alert or notification is generated and cannot be resolved, then the person receiving the wood could reject the wood at that time, thereby stopping the shipment of wood that potentially was illegally logged or entered into the supply chain. This provides yet another layer of security. In this manner, the entire lifecycle and physical location of trees and lumber can be tracked and verified.

In another embodiment, the handshake protocol can comprise a simple message, such as an SMS or MMS message, that records the transaction in a quick and simple manner, such as “Tree XYZ transferred to Person ABC.”

Optionally, mobile devices 110 can facilitate payment concurrently with the handshaking, where a payment is made by the receiver of the commodity to the supplier of the commodity. The payment can involve monetary transfers, bitcoin transfers, or transfers of other assets such as carbon credits.

Optionally, at any stage in the supply chain, someone can take a physical sample from the tree or its wood and obtain DNA data or isotope data (as described above for the tree before it was logged), upload the data to server 310, and compare that data to data already stored in server 310 (such as in table 325) to determine if the records for the item are accurate back to the original tree in the forest from which the item allegedly was obtained.

In another aspect of the embodiment, server 310 can compile data that indicates trustworthiness on the part of the registered individual. For example, it can maintain data regarding the track record or reporting accuracy of the landowner, logger, driver, shipper, miller, or other registered individual, such as the duration of the period in which the individual was registered with server 310, reporting number of verified actions that have been identified and/or confirmed involving that individual, the volume of throughput involving that person, such as the number of trees surveyed or logged, the volume or weight of wood transported or milled, the number of journeys or trips made, and the total distance traveled in those journeys or trips. Server 310 can report this data to other registered users, so that, for example, a miller will be able to determine the track record of the logger that is supplying wood to him or her. As another example, a government entity can modify its audit plans based on the track record of the individuals involved. For example, it might want to audit a newly-registered land owner more frequently than a land owner who has been registered for a significant amount of time without any discrepancies.

### Second Embodiment: Tree Tagging and Tracking

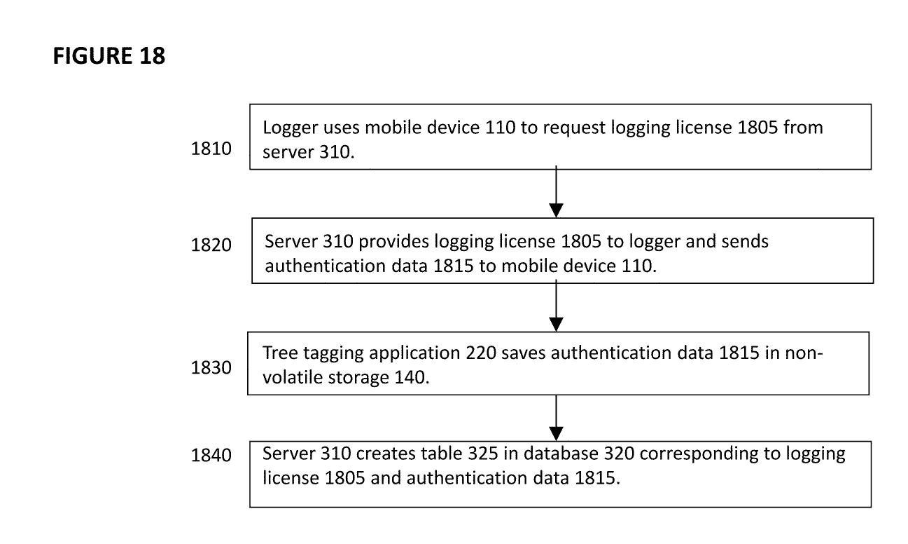

With reference to FIG. 18, a second embodiment is shown. A method is described whereby a logger uses mobile device 110 to obtain a logging license 1805. The logger uses mobile device 110 to request logging license 1805 from server 310 (step 1810). Server 310 provides logging license 1805 to logger and sends authentication data 1815 corresponding to logging license 1805 to mobile device 110 (step 1820). Certification application 220 saves authentication data 1815 in non-volatile storage 160 (step 1830). Server 310 creates table 325 in database 320 corresponding to logging license 1805 and authentication data 1815 (step 1840). In one embodiment, logging license 1805 can comprise a document issued by the government, and authentication data 1815 can comprise a code comprising a plurality of digits that is uniquely associated with logging license 1805. In one embodiment, authentication data 1815 can comprise a hash of certain information associated with logging license 1805 (e.g., a hash of the licensee's name, the license number, and the date and time the license was issued).

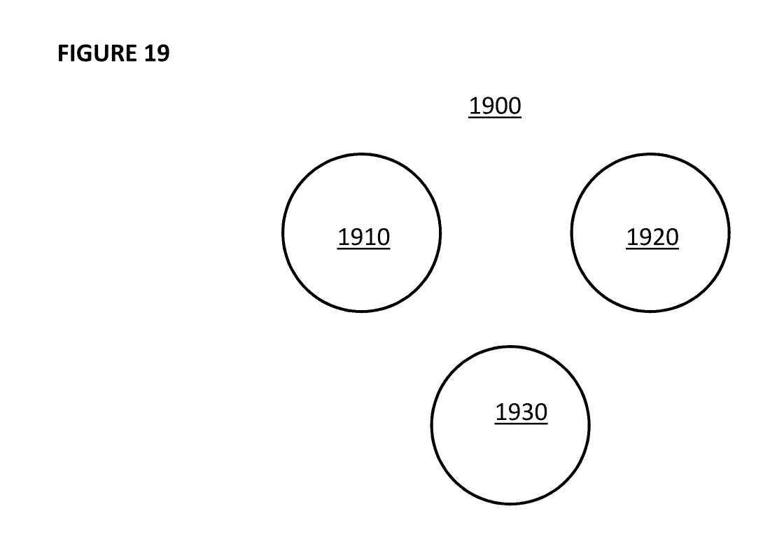

With reference to FIG. 19, a forest 1900 is depicted from a bird's eye view. Forest 1900 comprises tree 1910, tree 1920, and tree 1930. These trees are exemplary, and forest 1900 can comprise many more trees than the ones shown.

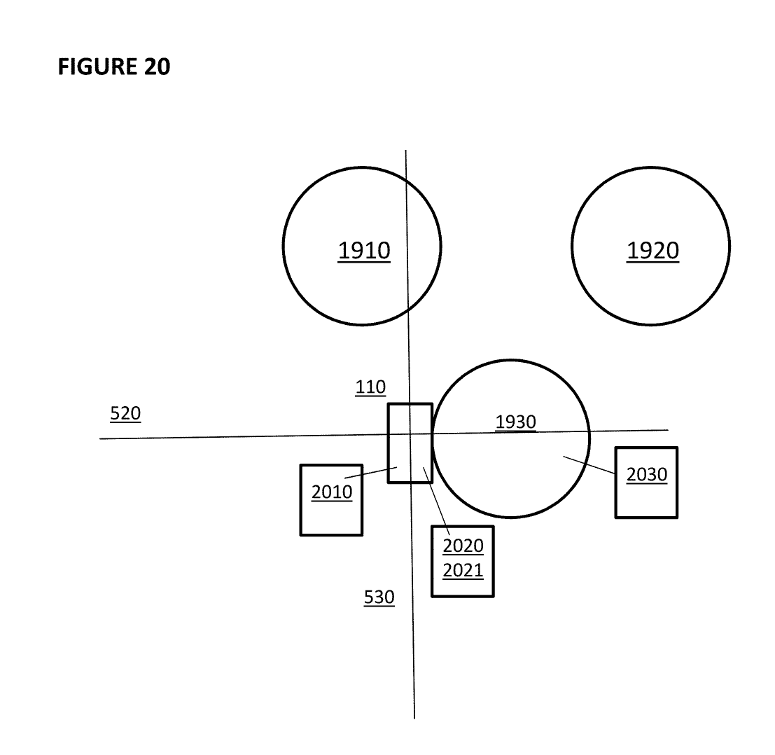

With reference to FIG. 20, in one embodiment, a logger who wishes to lawfully cut down tree 1930 pursuant to logging license 1805 uses mobile device 110 in the immediate vicinity of tree 1930. For example, he or she places mobile device 110 in contact with the trunk of tree 1930, or stands within a few feet of tree 1930, and uses certification application 220 to record the logging of tree 1930. For example certification application 220 can comprise a graphical user interface with a button labeled “Cut down tree.” When the logger pushes that button, mobile device 110 will determine its current position using a satellite system. For example, mobile device 110 can utilize GPS/GNSS coordinates using positioning unit 150 and GPS/GNSS satellites. The GPS/GNSS coordinates comprise latitude data 520 and longitude data 530. Latitude data 520 and longitude data 530 can be used to determine the location of mobile device 110 within a few feet. As another example, mobile device 110 can utilize positional coordinates using positioning unit 150 and GLONASS satellites. The positional coordinates also would comprise latitude data 520 and longitude data 530. Latitude data 520 and longitude data 530 can be used to determine the location of mobile device 110 within a few feet. Other satellite positioning systems can be used as well.

Certification application 220 creates a data record comprising latitude data 520 and longitude data 530 and date and time information 2010 (which is the date and time when the “Cut down tree” button was pressed). If mobile device 110 has wireless network connectivity at the time the button is pressed, mobile device 110 can communicate with server 310 to indicate that the logger has cut down a tree in the immediate vicinity of latitude data 520 and longitude data 530 at the date and time indicated by date and time information 2010. Server 310 can record that information in table 325. If mobile device 110 does not have wireless network connectivity when tree 1930 is cut down, then mobile device 110 will not communicate with server 310 at that time, but instead will send that information so as soon as it has network connectivity.

Optionally, the logger can place a ruler on the tree stump or the cut end of the tree and take a photograph (or infrared image) of the ruler against the tree stump or the cut end of the tree to generate evidence of the diameter of the tree stump and cut end of the tree as this can be used to calculate the volume of the tree, which serves as the baseline from which we can track the volume of the commodity as it moves along the supply chain. The size information can be stored in mobile device 110 and associate with the data record generated for the tree 1930. If image capture unit 180 is an infrared image capture device, then it is desirable to use a steel ruler for the measurement.

Optionally, mobile device 110 or server 310 can run an algorithm to determine the species of tree 1930 using characteristics such as physical location, diameter of the tree, color of the tree, the tree rings, and other factors. Optionally, the logger can input information indicating the species of tree into mobile device 110. This can be desirable, for instance, if the government wishes to regulate the number of trees cut per unit of land area based on the species of tree (e.g., no more than two mahogany trees cut down per acre of forest land).

Certification application 220, either on its own or in response to a command from server 310, optionally generates a certificate 2020 for tree 530. Certificate 2020 comprises a unique code 2021 (a tree tag) that is associated with tree 1930. Optionally, certificate 2020 comprises latitude data 520, longitude data 530, and date and time data 2010, or data generated from such data (such as a hash of that data). Certificate 2020 also can include information from authentication data 1815 or information that is generated using authentication data 1815. Under this approach, will not be able to generate certificate 2020 without having authentication data 1815, which will make the system more robust against fraud.

The logger can create representation 2030 of certificate 2020 and physically attach representation 2030 to tree 530. For example, representation 2030 can comprise a hard copy print out with a bar code, or it can comprise an RFID device that emits data that can be used to identify or generate certificate 2020.

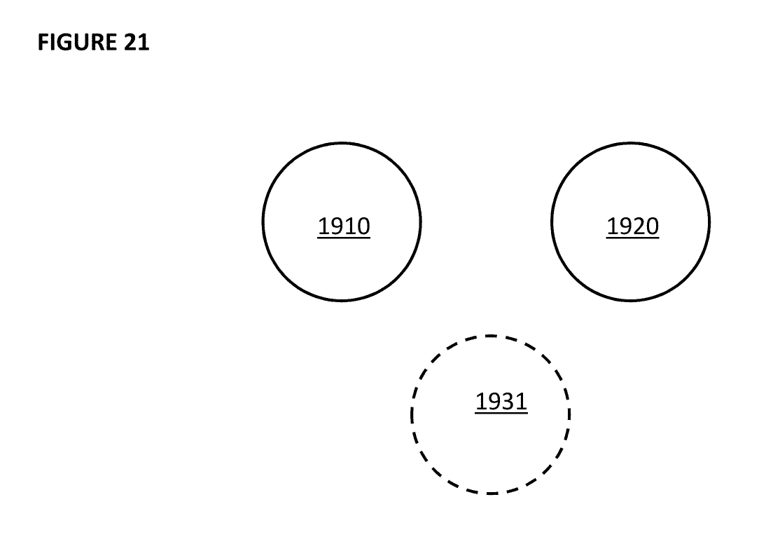

With reference to FIG. 21, tree 1930 is cut down by the logger. Tree 1930 no longer appears where it once was and is replaced by cavity 1931. Cavity 1931 may literally comprise a hole in the rainforest canopy where tree 1930 formerly stood, or it can comprise a disruption to the floor canopy that surrounded tree 1930 or a tree stump.

Recently, various companies and organizations have been using satellites to take extensive images of the earth's forests. With reference to FIG. 3, server 330 is a server that has access to such images. The images can include photographs, thermal and radar images, or other types of images. Server 310 requests satellite images from server 330. Specifically, after being informed by mobile device 110 that tree 1930 has been cut down, server 310 requests an image containing the area corresponding to latitude data 520 and longitude data 530 taken during a time preceding the date and time captured in date and time data 2010, and it requests an image containing that area taken during a time after the date and time captured in date and time data 2010.

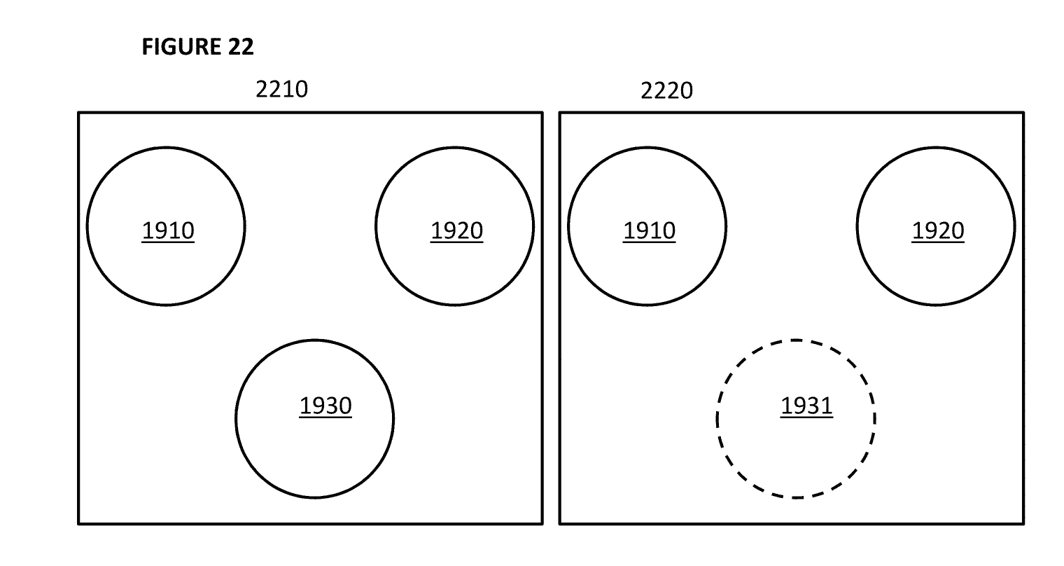

Thus, with reference to FIG. 22, server 310 obtains image 2210 that shows the existence of tree 1930 and image 2220 that shows cavity 1931 where tree 530 once appeared. Server 310 stores image 2210 and image 2220 and links them to table 525. Because date and time data 2010 may not indicate the exact time when tree 1930 was cut down, server 310 can request images that preceded and followed date and time data 2010 by a threshold amount X. For example, X can be 24 hours. If date and time data 2010 is, for example, May 4, 2016 at 7:56 am (eastern standard time), server 310 could request images taken at May 3, 2016 at 7:56 am and May 5, 2016 at 7:56 am. This would ensure that server 310 would obtain “before and after” images.

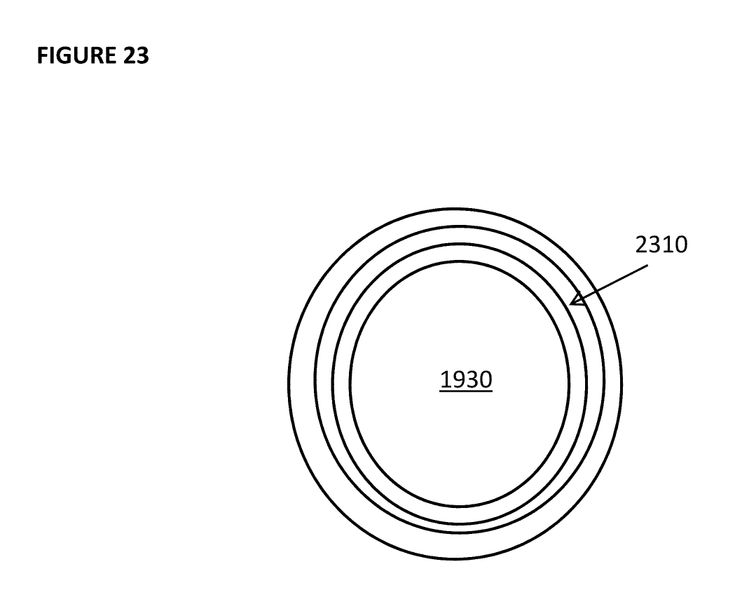

With reference to FIG. 23, the bottom of tree 1930 (which also is a cross-section of its trunk) is shown. The bottom of tree log face 1930 comprises unique indicators such as the shape of the circumference and tree rings 2310. One of ordinary skill in the art will appreciate that each tree has a unique set of attributes, just like fingerprints or facial biometrics are unique to each human being.

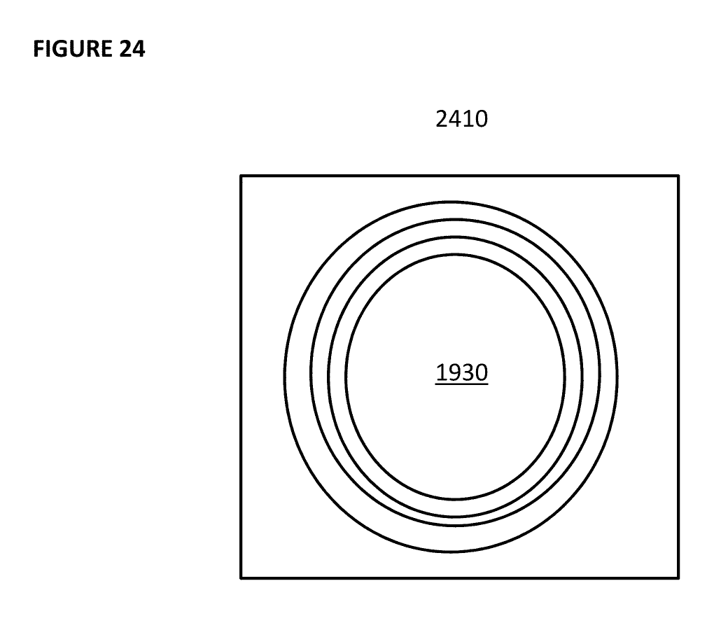

Optionally, with reference to FIG. 24, after tree 1930 is cut down, the logger can use mobile device 110 to take a photograph 2410 of the bottom of tree 1930. Mobile device 110 transmits photograph 2410 to server 310 either right after the photograph 2410 is taken or at a later time.

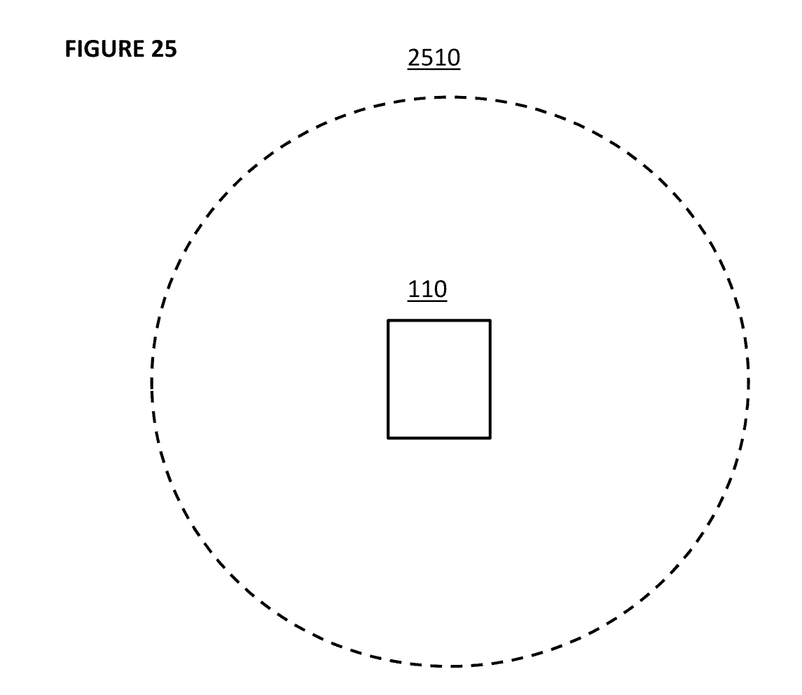

With reference to FIG. 25, if logging license 1805 contains geographical restrictions, mobile device 110 can be configured to operate within a geofence 2510 associated with those geographical restrictions. Geofence 2510 might be commensurate with a land area that previously had been surveyed. Geofence 2510 is the perimeter within which logging license 1805 permits logging. In one embodiment, certification application 220 will not permit mobile device 110 to obtain certificate 2020 if mobile device 110 is located outside of geofence 2510 at the time the request is made as indicated by latitude data 520 and longitude data 530. In another embodiment, server 310 does not issue certificate 2020 if mobile device 110 was located outside of geofence 2510 as indicated by latitude data 520 and longitude data 530. In another embodiment, if mobile device 110 requests a certificate when it is located outside of geofence 2510, server 310 can record that information, and a government authority can later punish or fine the logger for unlawful logging outside the scope of logging license 1805. Server 310 can further gather evidence of that transgression by capturing images 2210 and 2220.

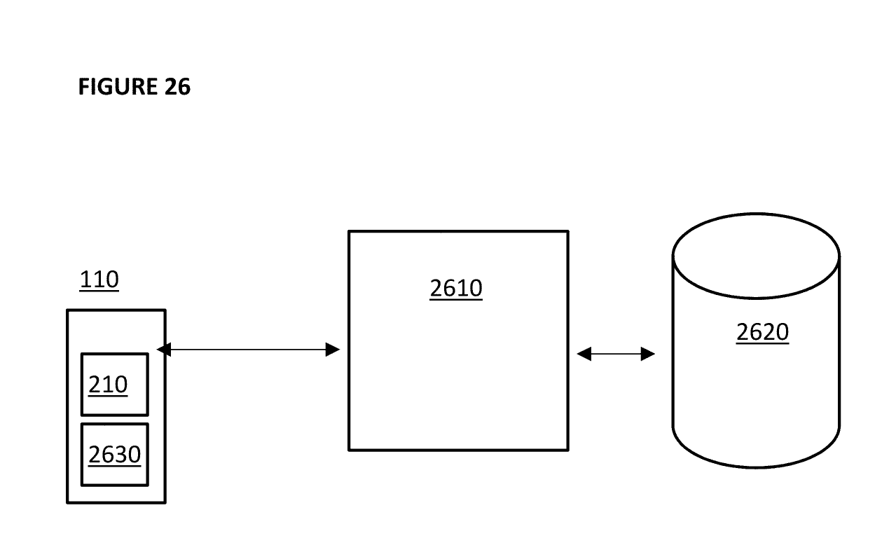

With reference to FIG. 26, when the logger wishes to export tree 1930 (or lumber or logs from tree 1930) out of the geographic jurisdiction, a governmental authority can use computing device 110 to determine whether tree 1930 was cut pursuant to a legitimate license. Computing device 110 in this instance runs software application 2630, which can be another app specially designed for use by the government. Using representation 2030 (such as by scanning a bar code or reading data from an RFID tag) or by inputting information from certificate 2020, the official can contact server 310, which will pull up table 325 and determine:

(1) Was certificate 2020 actually issued?

(2) Does image 2210 indicate the presence of a tree?

(3) Does image 2220 indicate the absence of a tree?

(4) Was any other tree cutting recorded for latitude data 520 and longitude data 530? An answer of “no” for question (1) might indicate potential illegal activity by the logger (e.g., a fake certificate). An answer of “yes” for question (2) and an answer of “yes” for question (3) might indicate potential illegal activity by the logger (e.g., certificate 2020 was not generated for a tree that was actually cut down and was not generated for the tree that is being exported). An answer of “yes” for question (4) also might indicate potential illegal activity by the logger (e.g., a fake certificate). However, an answer of “yes” for questions (1)-(3) and an answer of “no” for question (4) would indicate that tree 1930 was legitimately cut down, and the government can them allow the exportation of tree 1930.

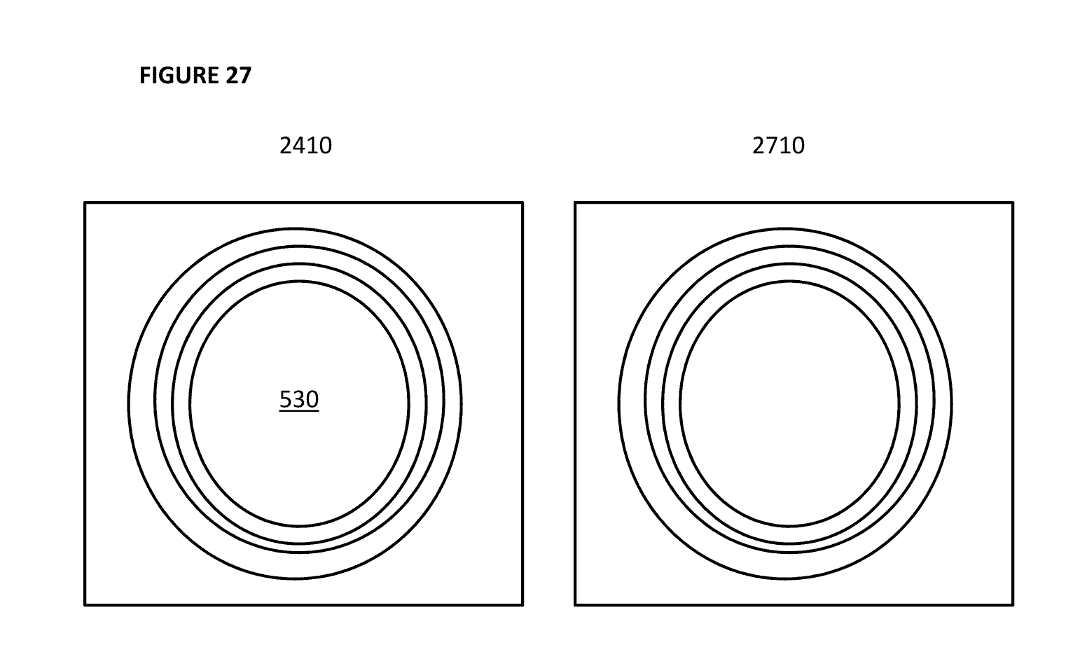

With reference to FIG. 27, in another embodiment, the government official uses device 110 to take a photograph 2710 of the bottom of the tree being exported. Server 310 then compares photograph 2710 with photograph 2410 to determine if they match. Each tree has a unique cross-section based on its size, circumference and tree rings. Each tree also will have unique markings or scars due to the actual cutting action used by the logger. Specifically, each tree obtains a unique “cerf mark” caused by the design of the saw, the force exerted by the logger with the saw against the tree, the timing of the cut, and a variety of other factors. Thus, there will be many bases for determining if the trees depicted in photograph 2710 and photograph 2410 match. If they do not match, then there may be potential illegal activity by the logger (e.g., he or she is exporting a different tree than the one that was cut down when the certificate was obtained). Such comparisons are possible, for example, by utilizing the biometrics of the cross-sections of the trees, as taught by W. A. Barrett in “Biometrics of Cut Tree Faces,” which is submitted herewith and is incorporated by reference.

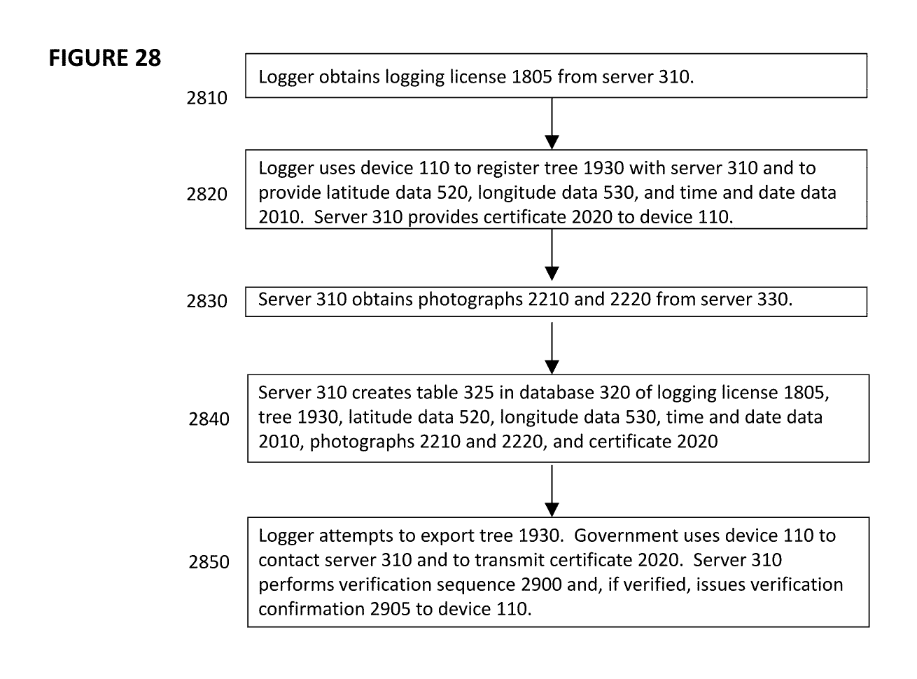

FIG. 28 summarizes an embodiment of a tree tagging method. Logger obtains logging license 1805 from server 310 (step 2810). Logger uses device 110 to register tree 1930 with server 310 and to provide latitude data 520, longitude data 530, and time and date data 2010. Server 310 provides certificate 2020 to device 110 (step 2820). Server 310 obtains images 2210 and 2220 from server 330 (step 2830). Server 310 creates table 325 in database 320 of logging license 1805, tree 1930, latitude data 520, longitude data 530, time and date data 2010, images 2210 and 2220, and certificate 2020 (step 2840). Logger attempts to export tree 1930. Government uses device 110 to contact server 310 and to transmit certificate 2020. Server 310 performs verification sequence 2900 and, if verified, issues verification confirmation 2905 to device 1110 (step 2850).

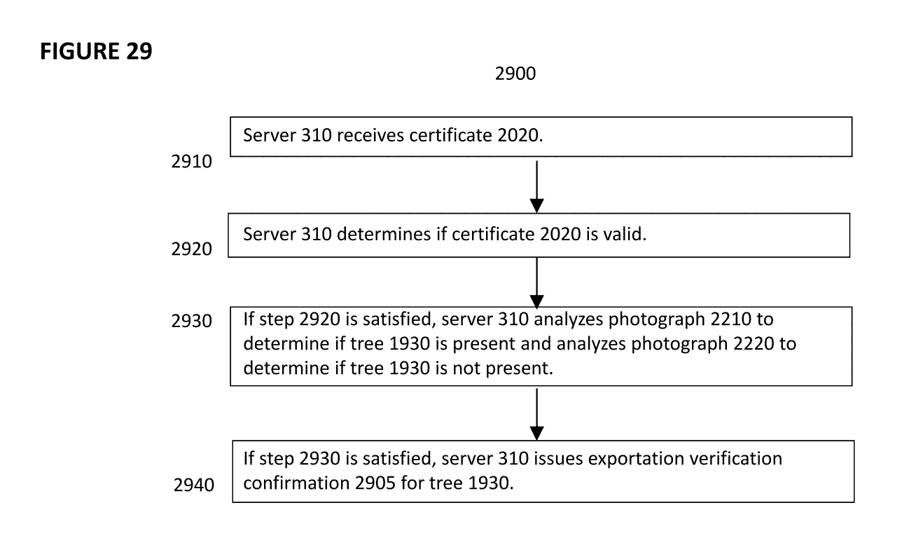

With reference to FIG. 29, additional detail regarding verification sequence 2900 is shown. Server 310 receives certificate 2020 (step 2910). Server 310 determines if certificate 2020 is valid (step 2920). If step 2920 is satisfied, server 310 analyzes image 2210 to determine if tree 1930 is present and analyzes image 2220 to determine if tree 1930 is not present (step 2930). If step 2930 is satisfied, server 310 issues exportation verification confirmation 2905 for tree 530 (step 2940).

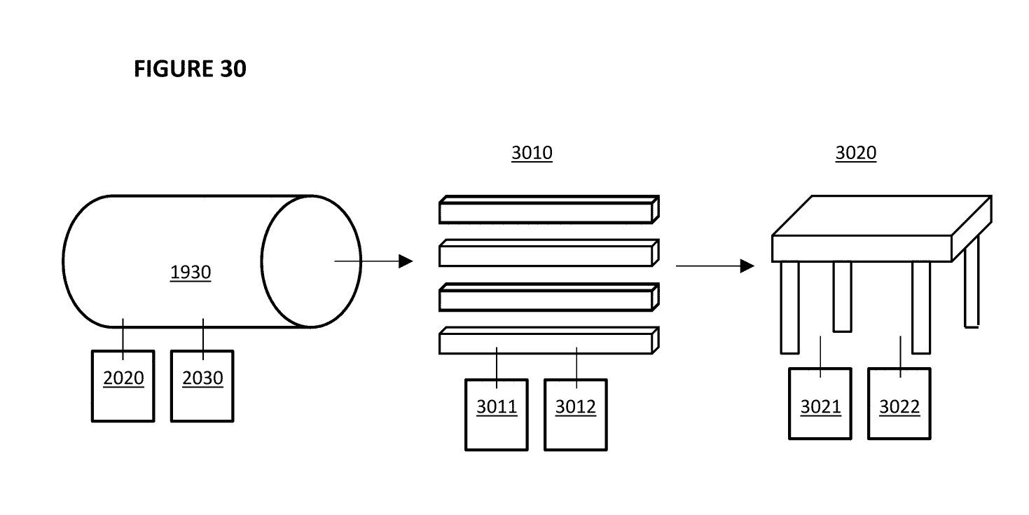

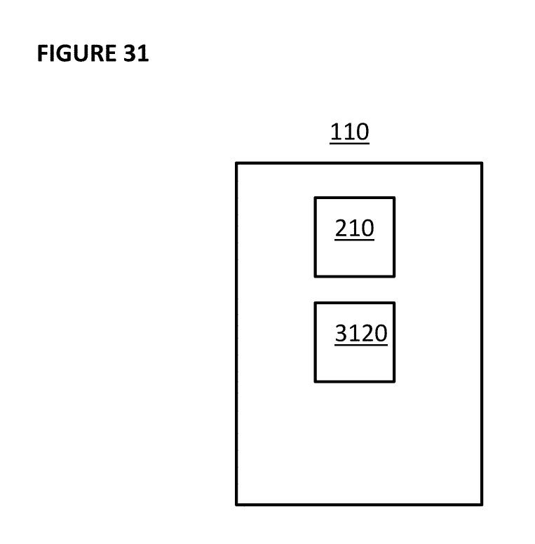

With reference to FIG. 30, another embodiment is depicted. In this example, tree 1930 is milled into lumber 3010, and lumber 3010 is then used to build furniture 3020. As discussed previously, tree 1930 is associated with certificate 2020 and representation 2030 of certificate 2020. When tree 1930 is milled into lumber 3010, a miller will send certificate 2020 to server 310 and request lumber certificate 3011. The miller can do this using computing device 110, shown in FIG. 31, which in this instance runs software application 3120, which can be another app specially designed for use by the miller. The miller can create representation 3012 of certificate 3011 (such as a hard copy print out with a bar code) and physically attach representation 3012 to lumber 3010. Representation 3012 also can be an RFID device that contains data associated with certificate 3011. Server 310 will generate a data record for lumber 3010, which will be associated with the data record for tree 1930, and will include an identifier for the lumber (which can be certificate 3011 itself or different data). Optionally, each piece of lumber 3010 can have its own or sub-identifier. For example, if lumber 3010 comprises twenty boards, each board can have an identifier comprising certificate 3011 and a sub-identifier such as Board-1, Board-2, . . . Board-N. In this manner, each item within lumber 3010 can be traced back to tree 1930. In this manner, the miller will be able to certify to its customers that lumber 3010 was obtained from a lawfully-obtained tree, tree 1930.

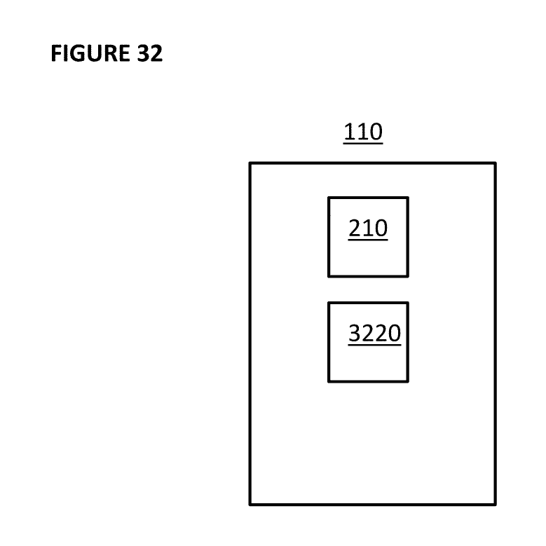

When lumber 3010 is used to build furniture 3020, a furniture maker will send certificate 3011 to server 310 and request furniture certificate 3021. The furniture maker can do this using computing device 110, shown in FIG. 32, which in this instance runs software application 3220, which can be another app specially designed for use by the furniture maker. Server 310 optionally can inform the furniture maker about tree 1930 and data about its origination—where tree 1930 was located, when it was cut down, by whom, etc. The furniture maker can create representation 3022 of certificate 3021 (such as a hard copy print out with a bar code) and physically attach representation 3022 to furniture 3020. Representation 3022 also can be an RFID device that contains data associated with certificate 3021. The furniture maker will be able to certify to its customers that furniture 3020 was obtained from lumber 3010, which was obtained from a lawfully-obtained tree, tree 1930.

The end consumer of furniture 3020 can then verify the history of furniture 3020 by accessing server 310 using certificate 3021 or representation 3022. This could be useful, for example, to verify that furniture 3020 was built from a tree that was logged pursuant to a valid government license, such as tree 1930. Thus, server 310 can be used to identify and monitor wood from the time tree 1930 is cut down to the time furniture 3020 is built. This will allow the government, millers, furniture makers, and end consumers to ensure that trees, lumber, and furniture is only sold when obtained pursuant to a lawful logging license.

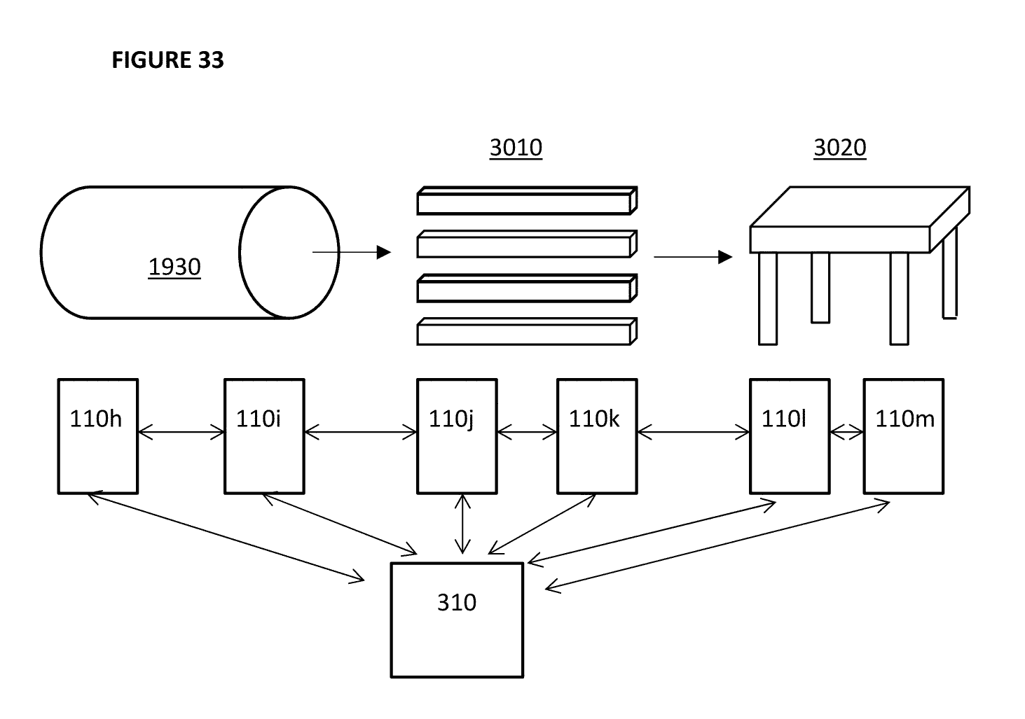

With reference to FIG. 33, an embodiment for tracking the movement and transfer of wood from the forest to the mill to the end consumer is disclosed. Tree 1930, lumber 3010, and furniture 3020 are shown as in FIG. 33. Mobile devices 110h, 110i, 110j, 110k, 110l, and 110m are instantiations of mobile device 110. In this example, mobile device 110h is operated by a logger, mobile device 110i is operated by a shipment company, mobile device 110j is operated by a miller, mobile device 110k is operated by another shipment company, mobile device 110l is operated by a furniture maker, and mobile device 110m is operated by a furniture store. Tree 1930 is cut down by the logger, transferred to the shipment company and then to the miller. The miller then cuts tree 1930 into lumber 3010 and transfers the lumber 3010 to the shipment company. The shipment company then transfers the lumber 3010 to the furniture maker, which makes furniture 3020 from lumber 3010 and provides furniture 3020 to the furniture store, which then sells furniture 3020 to an end consumer.

It should be understood that the first and second embodiments described above are not mutually exclusive, and that aspects of each can be utilized in any particular system.

Moreover, the first and second embodiments described herein can be useful in contexts other than lumber. For example, the supply chain instead might comprise individuals involved in the fishing industry or the manufacturing industry, where each person in supply chain receives or obtains a certain volume or weight of material and transfers it to the next person in supply chain. The certification method and system described herein might be useful in identifying illegal fishing activities where a fisherman exceeds the limit established by his fishing license.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between). For example, forming an element “over a substrate” can include forming the element directly on the substrate with no intermediate materials/elements there between, as well as forming the element indirectly on the substrate with one or more intermediate materials/elements there between.

1. A method of surveying a polygon of land and a plurality of trees contained within the polygon of land, comprising:
obtaining, by a mobile device, position information for a plurality of physical locations on a perimeter of the polygon of land;
storing, by the mobile device, the position information for the plurality of physical locations;
obtaining, by the mobile device, tree information for each of the plurality of trees, the tree information comprising position information for the tree, dimension information for the tree, and species information for the tree; and
transferring, by the mobile device to a server, the position information for the plurality of physical locations and the tree information for each of the plurality of trees.

2. The method of claim 1, wherein the dimension information for the tree comprises height information and circumference information.

3. The method of claim 1, wherein the position information for the plurality of physical locations comprises longitude data and latitude data for each of the plurality of physical locations.

4. The method of claim 3, wherein the position information for the tree comprises longitude data and latitude data for the tree.

5. The method of claim 1, wherein the tree information further comprises DNA information or isotope information.

6. The method of claim 1, further comprising:
generating, by the server, a data structure for the polygon of land and the plurality of trees; and
storing in the data structure, by the server, the position information for the plurality of physical locations and the tree information for each of the plurality of trees.

7. The method of claim 1, further comprising:
obtaining, by a second mobile device, tree verification information for at least one of the plurality of trees, the tree verification information comprising position information for the tree, dimension information for the tree, and species information for the tree; and
comparing, by the second mobile device or the server, the tree verification information for at least one of the plurality of trees against tree information stored for the tree in the data structure and indicating any differences.

8. A method of monitoring a supply chain for wood, comprising:
receiving, by a server from a first mobile device, first position information captured by the first mobile device for a tree before the tree has been cut down;
generating, by the server, a first volume estimate for wood contained in the tree;
generating, by the server based on data received from a second mobile device, a second volume estimate for wood contained in the tree after the tree has been cut down;
generating an alert, by the server, if the second volume estimate exceeds the first volume estimate by a threshold amount.

9. The method of claim 8, wherein the first position information comprises longitude data and longitude data.

10. The method of claim 9, wherein the second position information comprises longitude data and latitude data.

11. The method of claim 8, wherein the data received from the second mobile device comprises height data and circumference data for the tree.

12. The method of claim 8, further comprising:
generating an alert, by the server, if the second position information indicates a location that is not associated with a license for logging of trees.

13. A method of certifying a supply chain for wood, comprising:
capturing, by a first mobile device, a first set of time, date, and position information associated with a tree when it is cut down in a first location;
capturing, by a second mobile device, a second set of time, date, and position information associated with a tree when the tree is delivered to a second location; and
generating an alert if the volume of the tree exceeds the estimated volume of wood that can be logged from an area of land comprising the first location.

14. The method of claim 13, further comprising:
capturing, by a third mobile device, a third set of time, date, and location information associated with a tree when the tree is delivered to a third location.

15. The method of claim 14, further comprising:
generating an alert if the volume of the tree estimated at the third location exceeds the estimated volume of wood estimated at the second location.

16. The method of claim 13, wherein the position information in the first set of time, date, and position information comprises longitude data and latitude data.

17. The method of claim 16, wherein the position information in the second set of time, date, and position information comprises longitude data and latitude data.

18. A computing device comprising a processing unit and non-volatile storage, the non-volatile storage containing a computer program comprising instructions to be executed by the processing unit for performing the following steps:
receiving, by the computing device, a first set of transaction data for a first transaction involving a physical commodity, the first set of transaction data comprising identification information for one or more persons performing the first transaction, position information for the first transaction, a date and time for the first transaction, and identification information for the physical commodity; and
sending, by the computing device, a second set of transaction data for a second transaction involving the physical commodity, the second set of transaction data comprising identification information for one or more persons performing the second transaction, position information for the second transaction, a date and time for the second transaction, and identification information for the physical commodity.

19. The computing device of claim 18, wherein the position information for the first transaction comprises longitude data and latitude data and the position information for the second transaction comprises longitude data and latitude data.

20. The computing device of claim 18, wherein the computer program further comprises instructions to be executed by the processing unit for performing the following step:
after the receiving step, storing the first set of transaction data in a data structure associated with the physical commodity.

21. The computing device of claim 18, wherein the computing device is a mobile device.

22. The computing device of claim 18, wherein the first set of transaction data comprises dimension information for the physical commodity and the second set of transaction data comprises dimension information for the physical commodity.

23. The computing device of claim 18, wherein the first set of transaction data comprises volume information for the physical commodity and the second set of transaction data comprises volume information for the physical commodity.

24. The computing device of claim 18, wherein the first set of transaction data comprises DNA information or isotope information for the physical commodity and the second set of transaction data comprises DNA information or isotope information for the physical commodity.

25. The computing device of claim 18, wherein the first set of transaction data comprises position information for an origin of the physical commodity and the second set of transaction data comprises position information for the origin of the physical commodity.

26. The computing device of claim 18, wherein the computer program further comprises instructions to be executed by the processing unit for performing the following step:
writing some or all of the second set of transaction data for the second transaction to a blockchain.

27. A method of facilitating transactions for a physical commodity, comprising:
receiving, by a first computing device, a first set of transaction data for a first transaction involving a physical commodity, the first set of transaction data comprising identification information for one or more persons performing the first transaction, position information for the first transaction, a date and time for the first transaction, and identification information for the physical commodity; and
sending, by the first computing device, a second set of transaction data for a second transaction involving the physical commodity, the second set of transaction data comprising identification information for one or more persons performing the second transaction, position information for the second transaction, a date and time for the second transaction, and identification information for the physical commodity.

28. The method of claim 27, further comprising:
receiving, by a second computing device, the first set of transaction data;
receiving, by a second computing device, the second set of transaction data;
identifying, by the second computing device, differences between the first set of transaction data and the second set of transaction data.

29. The method of claim 28, further comprising:
generating an alert, by the second computing device, in response to one or more of the differences.

30. The method of claim 29, wherein the one or more differences comprises a difference in volume information for the physical commodity in the first set of transaction data and the second set of transaction data.

31. The method of claim 27, wherein the position information for the first transaction comprises longitude data and latitude data and the position information for the second transaction comprises longitude data and latitude data.

32. The method of claim 27, further comprising:
after the receiving step, storing the first set of transaction data in a data structure associated with the physical commodity.

33. The method of claim 27, wherein the first computing device is a mobile device.

34. The method of claim 27, wherein the first set of transaction data comprises dimension information for the physical commodity and the second set of transaction data comprises dimension information for the physical commodity.

35. The computing device of claim 27, wherein the first set of transaction data comprises volume information for the physical commodity and the second set of transaction data comprises volume information for the physical commodity.

36. The computing device of claim 27, wherein the first set of transaction data comprises DNA information or isotope information for the physical commodity and the second set of transaction data comprises DNA information or isotope information for the physical commodity.

37. The computing device of claim 27, wherein the first set of transaction data comprises position information for an origin of the physical commodity and the second set of transaction data comprises position information for the origin of the physical commodity.

38. The method of claim 27, further comprising:
receiving, by a second computing device, the second set of transaction data;
generating an alert, by the second computing device, if the position information for the second set of transaction data is outside of a predetermined geofence.

39. The method of claim 27, further comprising:
writing some or all of the second set of transaction data for the second transaction to a blockchain.

40. The method of claim 27, further comprising:
generating an alert, by the second computing device, in response to the identification information for one or more persons performing the first transaction.
